(19) United States
(12) Patent Application Publication
(10) Pub. No.: US 2026/0068854 A1
(43) Pub. Date: Mar. 12, 2026

(54) Pet Restraint Device

(71) Applicant: Clement Robert Hipple, Philadelphia, PA (US)

(72) Inventor: Clement Robert Hipple, Philadelphia, PA (US)

(21) Appl. No.: 19/396,005

(22) Filed: Nov. 20, 2025

Related U.S. Application Data
(63) Continuation-in-part of application No. 18/770,389, filed on Jul. 11, 2024, now Pat. No. 12,490,716.
Application No. 18/770,389 is a continuation-in-part of application No. 29/915,492, filed on Nov. 6, 2023, now Pat. No. D1091966.
(60) Provisional application No. 63/593,077, filed on Oct. 25, 2023.

(51) Int. Cl. A01K 15/04

(52) U.S. Cl. CPC A01K 15/04

(57) ABSTRACT

A pet restraint device is a device that allows the user to safely and comfortably restrain a pet so that the necessary pet care can be performed without aid from another person. The device includes a support base, a proximal restraining strap, a distal restraining strap, an intermediate restraining strap, a rear restraining band, and a neck restraining collar. The support base provides a large sturdy surface to accommodate the pet being restrained in a safe and comfortable manner. The support base also provides structural support to the proximal restraining strap, the intermediate restraining strap, the distal restraining strap, and the neck restraining collar. The proximal restraining strap, the intermediate restraining strap, the distal restraining strap, and the neck restraining collar enable the pet to be restrained without obstructing access to the pet's body. The rear restraining band prevents the pet from moving backwards when restrained to the support base.

### FIELD OF THE INVENTION

The present invention relates generally to pet accessories and veterinary supplies. More specifically, the present invention provides a pet restraint device that can safely accommodate various pets of different sizes.

### BACKGROUND OF THE INVENTION

Pet care can be an arduous task for pet owners and caregivers. For example, trying to keep a restless pet still while administering medication can be difficult for a single person. These situations often force two or more people to participate so one person can hold the pet down while the other person performs the task. To help maintain the pet temporarily restrained, various pet accessories and devices have been made available that eliminate the need for another person. For example, pet restraints have been made available to keep the pet still, such as for pet grooming purposes, that enables the pet grooming to be performed by a single person. However, these pet restraints can be uncomfortable for both the pet and the user. In addition, the available pet restraints can even obstruct the user when performing the desired pet care. Therefore, there is a need for a better pet restraint device that securely and comfortably restraints a pet of any size without drastically obstructing the pet's body.

The objective of the present invention is to provide a pet restraint device that can be used by veterinarians and pet owners to securely restraint pets in different positions without harming the pet. The present invention enables the pet to be restrained in any position including, but not limited to, on their back, stomach, or side, without obstructing the pet's body. Another objective is to provide a pet restraint device that can accommodate pets of different sizes. The present invention allows pets of different sizes to be restrained to perform the desired pet care. Another objective is to provide a pet restraint device that can be easily set up without the use of external tools. The present invention includes various strap fasteners that can be selectively engaged to comfortably retain the pet's body without the use of additional external tools. The strap fasteners can be arranged to provide lateral support to the pet's body as well as to prevent the pet from coming loose. Additional features and benefits of the present invention are further discussed in the sections below.

### SUMMARY OF THE INVENTION

The present invention discloses a pet restraint device. The pet restraint device can be used to restrain a pet so that the user can safely perform different pet care tasks on the pet without harming the pet. For example, the present invention can be used to administer some type of medication to the pet. The present invention helps to safely perform various grooming tasks such as trimming the pet's nails. The present invention allows the veterinarians to take control of the animal and restrain the animal without the assistance of another person. This way, the veterinarian can provide the animal with injections, take the body temperature, administer medication, take blood samples, perform medical examinations, etc. In general, the present invention may include a support base, several restraining straps, and a neck restraining collar. The support base provides structural support to the pet when restrained by the restraining straps. The restraining straps can be adjusted to accommodate the pet's body without largely obstructing the pet's body. The neck restraining collar further secures the pet's body to the support base to prevent the restrained pet from getting loose.

In some embodiments, the restraining straps can be secured to the support base in different ways that allow the pet to be comfortably restrained to the support base. For example, the restraining straps can be permanently fixed to the bottom surface of the support base. The restraining straps can also be removably attached to the support base using fasteners so that only the necessary straps are attached to the support base. Further, the support base can also include hooks that allow the restraining straps to be securely attached without the use of fasteners. Furthermore, the present invention may include a rear restraining band that prevents the pet from getting loose. In other embodiments, additional restraining features can be provided to further restrain the pet in a safe and comfortable manner.

### BRIEF DESCRIPTION OF THE DRAWINGS

FIG. 1 is a top-front-left perspective view of the present invention, wherein the restraining straps are shown unfastened, and wherein the neck restraining collar is shown unfastened.

FIG. 2 is a bottom-front-left perspective view of the present invention thereof.

FIG. 3 is a top-rear-right perspective view of the present invention thereof.

FIG. 4 is a bottom-rear-right perspective view of the present invention thereof.

FIG. 5 is a top-front-left perspective view of the present invention, wherein the restraining straps are shown fastened, wherein the neck restraining collar is also shown fastened, and wherein the present invention is shown with a chest restraining band and a rear restraining band.

FIG. 6 is a top-rear-right perspective view of the present invention thereof.

FIG. 7 is a left view of the present invention thereof.

FIG. 8 is a top view of the present invention thereof.

FIG. 9 is a top-front-left perspective view of the present invention, wherein the present invention is shown without the neck restraining collar, wherein the restraining straps are shown fastened, and wherein the present invention is shown with a single intermediate restraining strap.

### DETAIL DESCRIPTIONS OF THE INVENTION

All illustrations of the drawings are for the purpose of describing selected versions of the present invention and are not intended to limit the scope of the present invention.

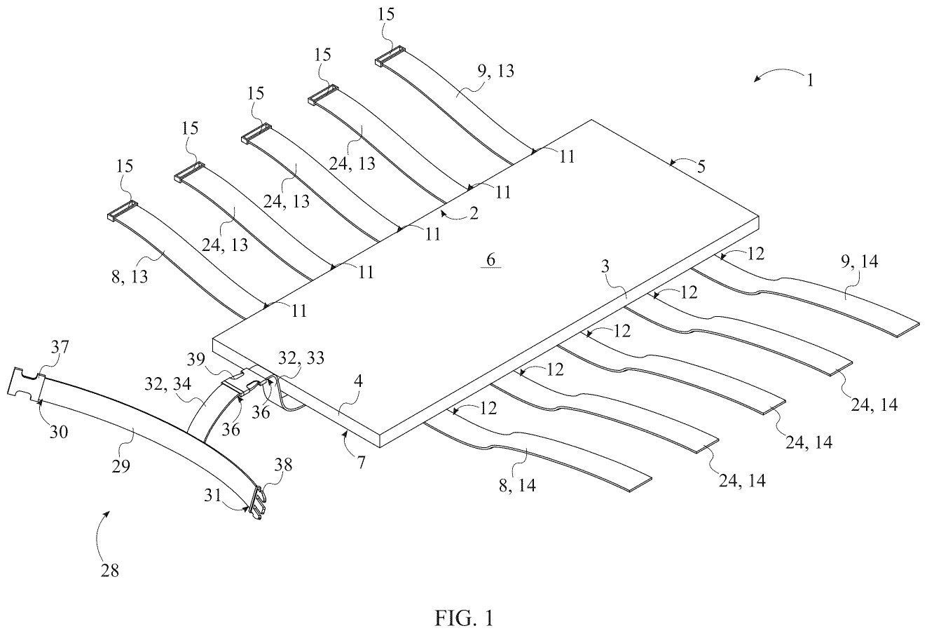

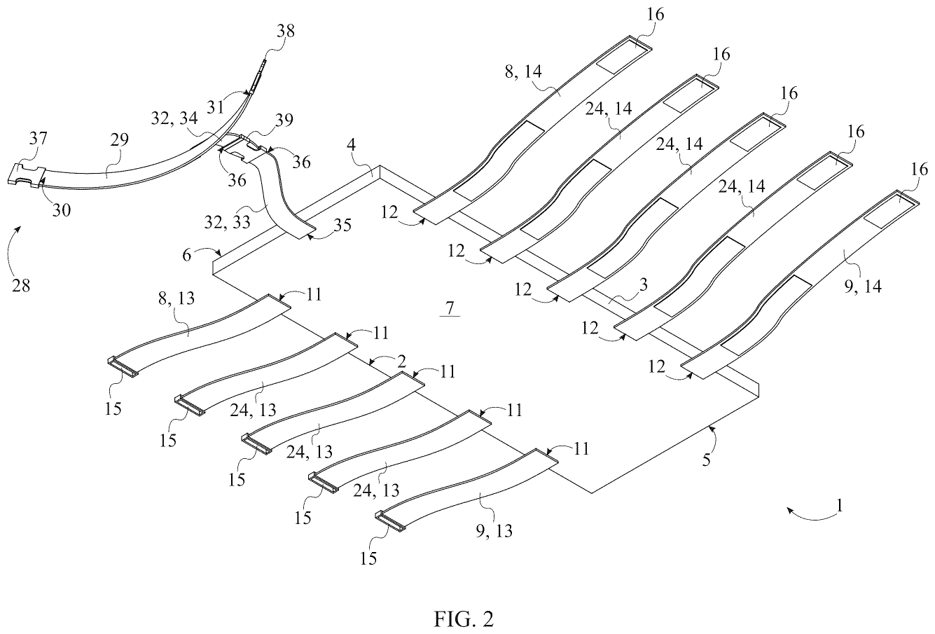

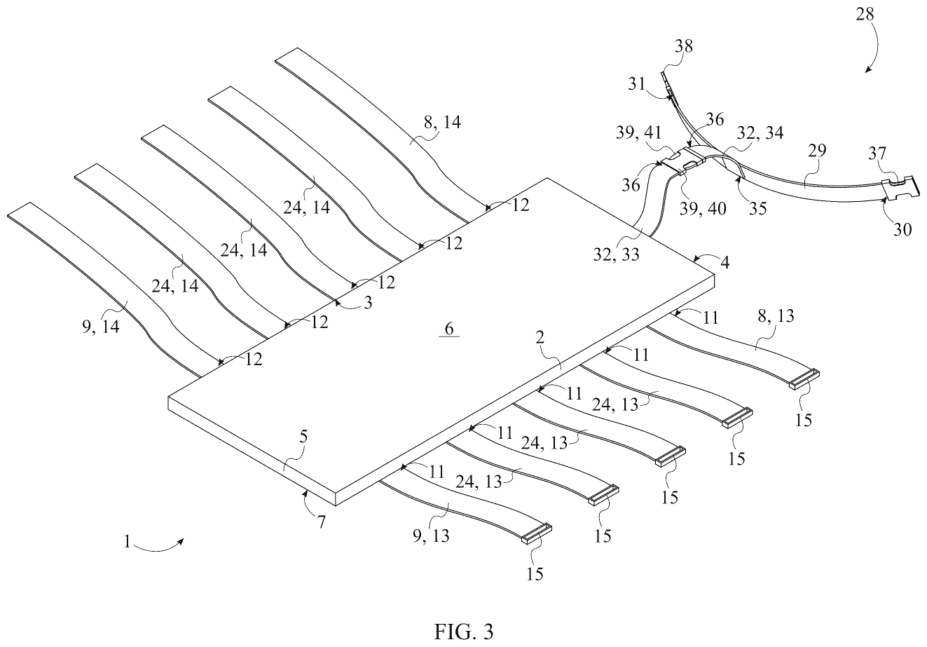

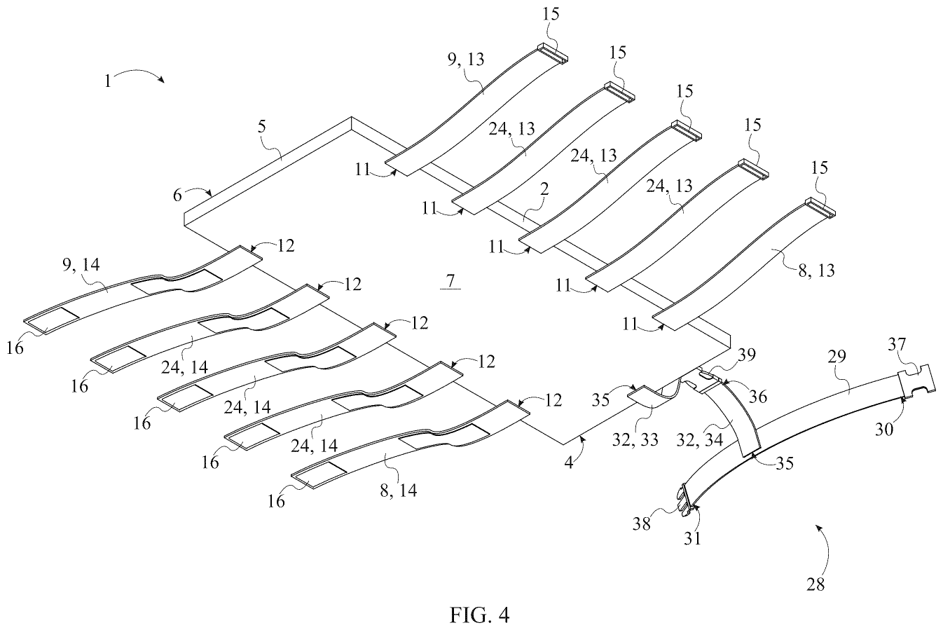

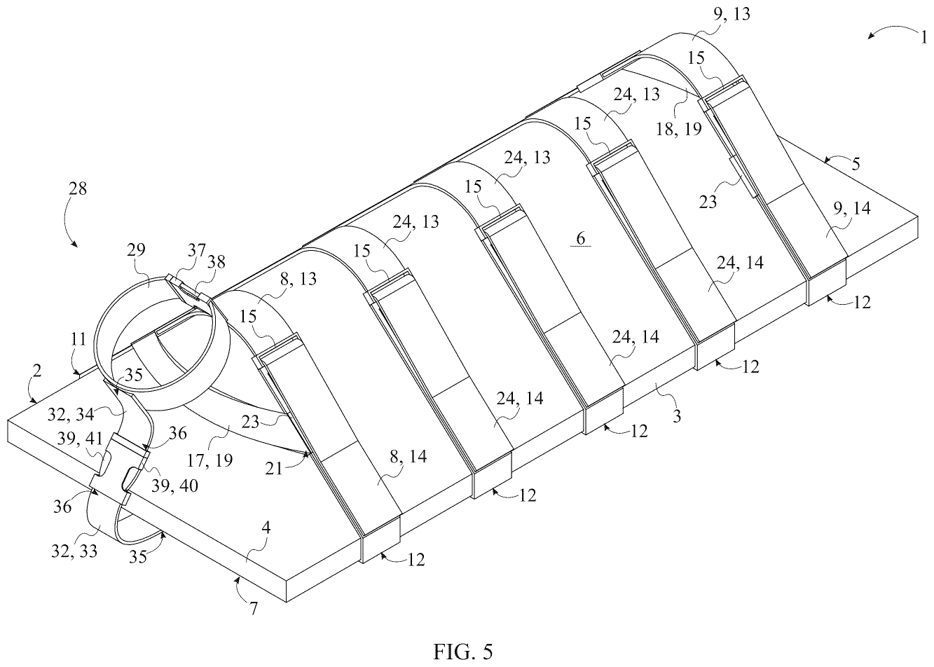

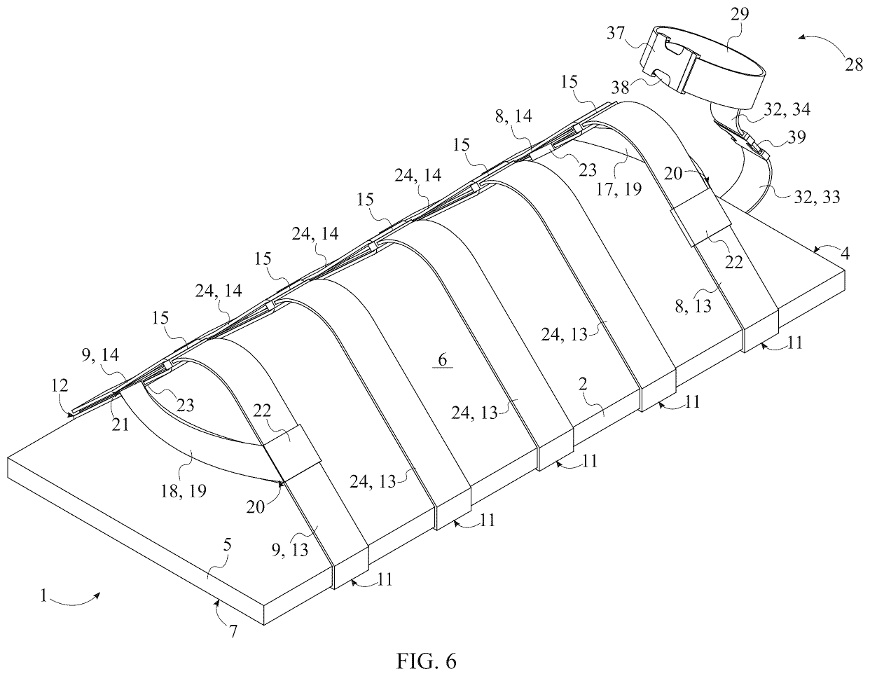

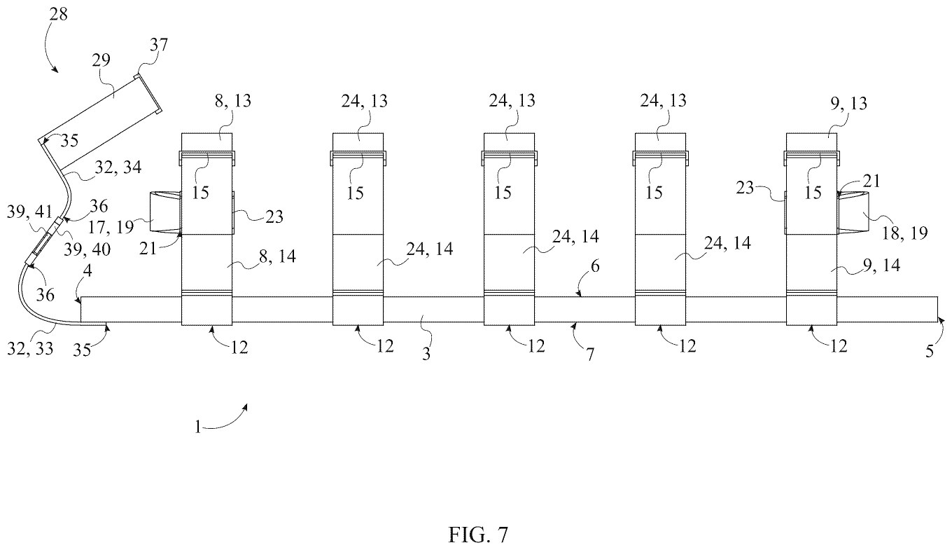

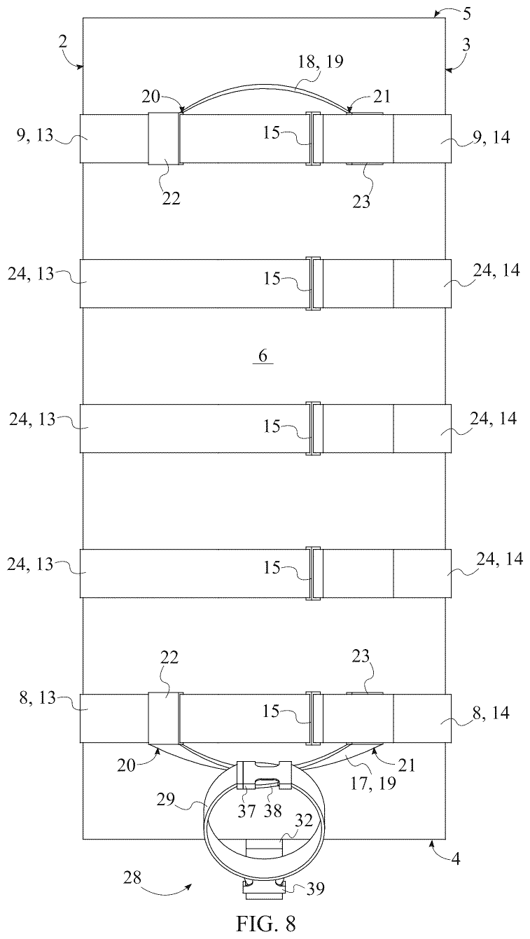

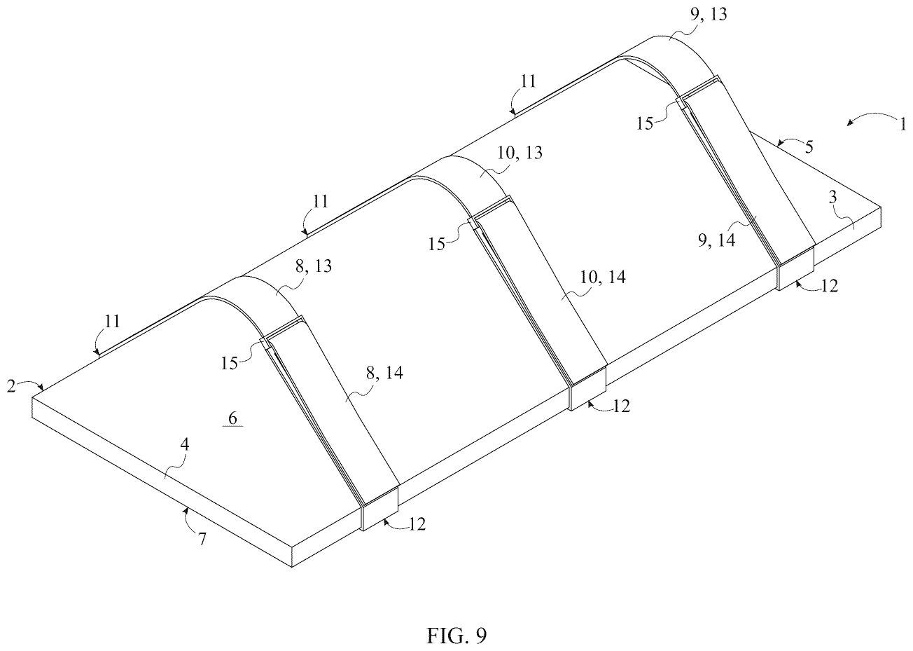

The present invention discloses a pet restraint device. The present invention allows the user to safely and comfortably restrain a pet so that the user can perform the necessary pet care without aid from another person. In the preferred embodiment, the present invention comprises a support base 1, a proximal restraining strap 8, a distal restraining strap 9, at least one intermediate restraining strap 10, a rear restraining band 18, and a neck restraining collar 28, as can be seen in FIGS. 1 through 9. The support base 1 provides a sturdy surface that is large enough to accommodate the pet being restrained in a safe and comfortable manner. The support base 1 also provides a structure where the proximal restraining strap 8, the at least one intermediate restraining strap 10, the distal restraining strap 9, and the neck restraining collar 28 can be securely attached to. The proximal restraining strap 8, the at least one intermediate restraining strap 10, the distal restraining strap 9, and the neck restraining collar 28 enable the user to restrain the pet to the support base 1 in a safe manner without covering the pet's body. This way, the user can have easier access to the pet's body to perform the necessary pet care. The proximal restraining strap 8, the at least one intermediate restraining strap 10, the distal restraining strap 9, and the neck restraining collar 28 can be adjusted to match the pet's body. The rear restraining band 18 prevents the pet from moving backwards when restrained to the support base 1.

The general configuration of the aforementioned components enables the user to safely restrain a pet without additional help from another person. The support base 1 is an elongated flat surface large enough to accommodate a wide variety of pets including, but not limited to, dogs, cats, etc. The support base 1 can also have different shapes and designs such as a rectangular shape, a square shape, etc. In general, the support base 1 comprises a first lengthwise edge 2, a second lengthwise edge 3, a first widthwise edge 4, and a second widthwise edge 5, as can be seen in FIGS. 1 through 9. The first lengthwise edge 2 and the second lengthwise edge 3 correspond to the longer opposite lateral edges of the support base 1. Further, the first widthwise edge 4 and the second widthwise edge 5 correspond to the shorter opposite lateral edges of the support base 1. Moreover, the proximal restraining strap 8, the at least one intermediate restraining strap 10, and the distal restraining strap 9 are length-adjustable straps that can be wrapped around different sections of the pet's body. For example, each restraining strap can be a two-inch (in.) strap made from nylon securing cord. In addition, the proximal restraining strap 8, the at least one intermediate restraining strap 10, and the distal restraining strap 9 each comprises a first strap end 11 and a second strap end 12 corresponding to the terminal ends of each restraining strap.

Further, the rear restraining band 18 corresponds to an elongated band with a width large enough to comfortably restrain the pet's body. As can be seen in FIGS. 1 through 9, the rear restraining band 18 comprises a band body 19, a first band end 20, a second band end 21, a first band loop 22, and a second band loop 23. The band body 19 corresponds to the elongated flexible structure of the rear restraining band 18. The first band end 20 and the second band end 21 each corresponds to the terminal ends of the rear restraining band 18. Further, the first band loop 22 and the second band loop 23 correspond to the attachment features that facilitates the attachment of the rear restraining band 18 to the corresponding restraining strap. Furthermore, the neck restraining collar 28 is a tethered collar that keeps the pet's head in position when restrained on the support base 1. The neck restraining collar 28 further prevents the restrained pet from getting loose when restrained.

In the preferred embodiment, the present invention can be arranged as follows: the proximal restraining strap 8, the at least one intermediate restraining strap 10, and the distal restraining strap 9 are distributed along the support base 1 to accommodate the pet's body size, as can be seen in FIGS. 1 through 9. The proximal restraining strap 8 is positioned adjacent to the first widthwise edge 4 so that the proximal restraining strap 8 can be wrapped around the pet's front side. The distal restraining strap 9 is positioned adjacent to the second widthwise edge 5 so that the distal restraining strap 9 can be wrapped around the pet's rear side. The at least one intermediate restraining strap 10 is positioned in between the proximal restraining strap 8 and the distal restraining strap 9 so that the at least one intermediate restraining strap 10 can be wrapped around the pet's mid-section.

Further, the first strap end 11 of the proximal restraining strap 8, the first strap end 11 of the at least one intermediate restraining strap 10, and the first strap end 11 of the distal restraining strap 9 are each mounted onto the support base 1, adjacent to the first lengthwise edge 2, as can be seen in FIGS. 1 through 9. This way, the first strap end 11 of each restraining strap is secured to the support base 1 close to the first lengthwise edge 2. On the other hand, the second strap end 12 of the proximal restraining strap 8, the second strap end 12 of the at least one intermediate restraining strap 10, and the second strap end 12 of the distal restraining strap 9 are each mounted onto the support base 1, adjacent to the second lengthwise edge 3. This way, the second strap end 12 of each restraining strap is also secured to the support base 1 close to the second lengthwise edge 3. In other embodiments, each restraining strap can be arranged in different configurations around the support base 1.

Moreover, the first band end 20 is positioned opposite to the second band end 21 along the band body 19 due to the elongated design of the rear restraining band 18, as can be seen in FIGS. 1 through 9. The first band loop 22 is terminally integrated into the first band end 20 to secure the first band loop 22 to the rear restraining band 18. Similarly, the second band loop 23 is also terminally integrated into the second band end 21 to secure the second band loop 23 to the rear restraining band 18. Further, the first band loop 22 is positioned adjacent to the first lengthwise edge 2, while the second band loop 23 is positioned adjacent to the second lengthwise edge 3. This way, the rear restraining band 18 matches the arrangement of the other restraining straps. Further, the distal restraining strap 9 is slidably engaged through the first band loop 22 and the second band loop 23 of the rear restraining band 18 so that the rear restraining band 18 is secured to the distal restraining strap 9. In addition, the neck restraining collar 28 is positioned adjacent to the proximal restraining strap 8 so that the neck restraining collar 28 is positioned opposite to the rear restraining band 18. Furthermore, the neck restraining collar 28 is tethered to the support base 1, adjacent to the first widthwise edge 4, to secure the neck restraining collar 28 to the support base 1.

As previously discussed, the neck restraining collar 28 is adjustable to accommodate pets of different sizes. In some embodiments, the neck restraining collar 28 comprises a collar body 29 and a tethering strap 32, as can be seen in FIGS. 1 through 9. The collar body 29 corresponds to the main structure of the neck restraining collar 28 that is wrapped around the pet's neck. The tethering strap 32 helps secure the collar body 29 to the support base 1. To implement the collar body 29 and the tethering strap 32, the tethering strap 32 is terminally connected to the support base 1. This secures the tethering strap 32 to the support base 1 at one end. Further, the tethering strap 32 is terminally connected to the collar body 29, opposite to the support base 1. This allows the collar body 29 to be secured to the tethering strap 32 at the opposite end. Thus, the pet's neck can be secured to the support base 1 to further restrain the pet.

The collar body 29 is preferably provided as a length-adjustable collar that can be removably attached to the pet's neck. As can be seen in FIGS. 1 through 9, the present invention may further comprise a first collar fastener piece 37 and a second collar fastener piece 38 that allow the removable attachment of the collar body 29 to the pet's neck. In addition, the collar body 29 comprises a first collar end 30 and a second collar end 31 corresponding to the terminal ends of the collar body 29. To implement the first collar fastener piece 37 and a second collar fastener piece 38, the first collar fastener piece 37 is mounted onto the collar body 29, adjacent to the first collar end 30. This secures the first collar fastener piece 37 to the collar body 29 close to the first collar end 30. Similarly, the second collar fastener piece 38 is mounted onto the collar body 29, adjacent to the second collar end 31. This secures the second collar fastener piece 38 to the collar body 29 close to the second collar end 31. The first collar fastener piece 37 and a second collar fastener piece 38 are preferably the male and the female pieces of a release buckle. The collar ends can be looped through the corresponding fastener piece so that the working length of the collar body 29 can be adjusted. Once the working length of the collar body 29 is adjusted as necessary, the collar body 29 is wrapped around the pet's neck. Then, the first collar fastener piece 37 is engaged with the second collar fastener piece 38 to secure the collar body 29 to the pet's neck.

Similar to the collar body 29 the tethering strap 32 can be provided as a length-adjustable strap to accommodate pets of different sizes, as can be seen in FIGS. 1 through 9. In addition, the tethering strap 32 can be provided as a releasable strap that allows the collar body 29 to be removed from the support base 1. So, a first strap fastener 39 can be provided that allows the releasable attachment of the collar body 29 to the support base 1. In addition, the tethering strap 32 may comprise a proximal strap section 33 and a distal strap section 34 corresponding to two separate strap sections that are connected using the first strap fastener 39. Further, the proximal strap section 33 and the distal strap section 34 each comprises a fixed section end 35 and a free section end 36 corresponding the terminal ends of each strap section.

To implement this embodiment of the tethering strap 32, the fixed section end 35 of the proximal strap section 33 is centrally positioned along the first widthwise edge 4, as can be seen in FIGS. 1 through 9. This keeps the pet's head centered on the support base 1 when the pet's neck is restrained using the neck restraining collar 28. The fixed section end of the proximal strap section 35 is also terminally connected to the support base 1 to secure the proximal strap section 35 to the support base 1. On the other hand, the fixed section end 35 of the distal strap section 34 is terminally connected to the collar body 29 to secure the distal strap section 34 to the collar body 29. Further, to releasably attach the distal strap section 34 to the proximal strap section 33, the free section end 36 of the proximal strap section 33 is connected to the free section end 36 of the distal strap section 34 by the first strap fastener 39.

Different types of strap fasteners can be utilized for the first strap fastener 39. In some embodiments, the first strap fastener 39 may comprise a proximal fastener piece 40 and a distal fastener piece 41 corresponding to the male and female pieces of a release buckle, as can be seen in FIGS. 1 through 9. The proximal fastener piece 40 is preferably mounted onto the proximal strap section 33, adjacent to the free section end 36 of the proximal strap section 33. This secures the proximal fastener piece 40 to the proximal strap section 33. The proximal strap section 33 can be looped through the proximal fastener piece 40 so that the user can adjust the working length of the proximal strap section 33. On the other hand, the distal fastener piece 41 is mounted onto the distal strap section 34, adjacent to the free section end 36 of the distal strap section 34. This secures the distal fastener piece 41 to the distal strap section 34. Then, to secure the distal strap section 34 to the proximal strap section 33, the proximal fastener piece 40 is engaged with the distal fastener piece 41. In other embodiments, the tethering strap 32 can be provided as a strap of fixed length. Different fasteners can also be utilized for the first strap fastener 39.

As previously discussed, the support base 1 can have different shapes and sizes. In one embodiment, the support base 1 is a rectangular base large enough to accommodate the desired pet. In this embodiment, the first lengthwise edge 2 is positioned parallel and opposite to the second lengthwise edge 3 across the support base 1 due to the rectangular shape of the support base 1, as can be seen in FIGS. 1 through 9.

Similarly, the first widthwise edge 4 is also positioned parallel and opposite to the second widthwise edge 5 across the support base 1 due to the rectangular shape of the support base 1. The size of the support base 1 can be modified to accommodate specific pets and breeds. For example, the support base 1 can have a length of 34 in. and a width of 15 in. The thickness of the support base 1 can also vary depending on the material used to make the support base 1. Further, the first lengthwise edge 2 is positioned perpendicular to the first widthwise edge 4 due to the rectangular shape of the support base 1 as well. Further, the proximal restraining strap 8, the at least one intermediate restraining strap 10, and the distal restraining strap 9 are positioned parallel to each other to restrain the pet's body in a comfortable and secure manner. Each restraining strap can be equally spaced at four in. away from each other along the support base 1. In addition, the proximal restraining strap 8 can be positioned four in. away from the first widthwise edge 4, and the distal restraining strap 9 can also be positioned four in. away from the second widthwise edge 5. In alternate embodiments, the restraining straps can be rearranged to match different shapes of the support base 1.

In some embodiments, the present invention can include additional restraining features to prevent the pet from coming loose when restrained on the present invention or to limit movement of the pet's limbs. The present invention may further comprise a chest restraining band 17 that prevents the pet from moving forward when restrained to the support base 1, as can be seen in FIGS. 1 through 9. Similar to the rear restraining band 18, the chest restraining band 17 can correspond to an elongated band with a width large enough to comfortably restrain the pet's chest. The chest restraining band 17 can be used along with the neck restraining collar 28 to further prevent the movement of the restrained pet. The chest restraining band 17 may also comprise a band body 19, a first band end 20, a second band end 21, a first band loop 22, and a second band loop 23. The band body 19 corresponds to the elongated structure of the chest restraining band 17. The first band end 20 and the second band end 21 correspond to the terminal ends of the chest restraining band 17. The first band loop 22 and the second band loop 23 also correspond to the attachment features that facilitate the attachment of the chest restraining band 17 to the corresponding restraining strap.

As can be seen in FIGS. 1 through 9, the chest restraining band 17 can be implemented as follows: the first band end 20 is positioned opposite to the second band end 21 along the band body 19 due to the elongated structure of the chest restraining band 17. The first band loop 22 is terminally integrated into the first band end 20 to secure the first band loop 22 to the chest restraining band 17. Similarly, the second band loop 23 is also terminally integrated into the second band end 21 to secure the second band loop 23 to the chest restraining band 17. Further, the first band loop 22 is positioned adjacent to the first lengthwise edge 2, while the second band loop 23 is positioned adjacent to the second lengthwise edge 3. This way, the chest restraining band 17 matches the arrangement of the other restraining straps. Further, the proximal restraining strap 8 is slidably engaged through the first band loop 22 and the second band loop 23 of the chest restraining band 17 so that the chest restraining band 17 is secured to the proximal restraining strap 8. In other embodiments, the chest restraining band 17 can be implemented differently.

As previously discussed, the restraining straps are provided as length-adjustable straps that can be adjusted to match the pet's body size. As can be seen in FIGS. 1 through 9, the proximal restraining strap 8, the at least one intermediate restraining strap 10, and the distal restraining strap 9 may each further comprise a first strap member 13, a second strap member 14, and a strap eyelet 15. The first strap member 13 and the second strap member 14 correspond to the two separate members of each restraining strap that can be fastened to each other at different lengths to adjust the working length of the corresponding restraining strap. Each restraining strap can be arranged as follows: the first strap member 13 is positioned coincident to the first strap end 11, while the second strap member 14 is positioned coincident to the second strap end 12. This way, each strap member is positioned at opposite lengthwise edges of the support base 1. In addition, the strap eyelet 15 is terminally connected to the first strap member 13, offset from the first strap end 11, to secure the strap eyelet 15 to the free end of the first strap member 13.

Further, to connect the two strap members together, the second strap member 14 is looped through the strap eyelet 15, offset from the second strap end 12. This way, the user can adjust the working length of each restraining strap to accommodate the overall size of the pet's body.

To secure the working length of each restraining strap, the proximal restraining strap 8, the at least one intermediate restraining strap 10, and the distal restraining strap 9 may each further comprise a second strap fastener 16, as can be seen in FIGS. 1 through 9. The second strap fastener 16 allows the user to secure the working length of the corresponding restraining strap to ensure that the pet is securely restrained to the support base 1. To do so, the second strap fastener 16 is mounted onto the second strap member 14, offset from the second strap end 12, so that the second strap fastener 16 is secured to the second strap member 14. Thus, when the second strap member 14 is looped through the strap eyelet 15, the second strap fastener 16 can be attached onto the second strap member 14, adjacent to the second strap end 12. For example, the second strap fastener 16 can be a hook and loop fastener, with the hook portion of the second strap fastener 16 being positioned adjacent to the free end of the second strap member 14. The loop portion of the second strap fastener 16 can be provided adjacent to the second strap end 12. This way, the user can engage the hook portion to the loop portion of the second strap fastener 16 at different lengths along the second strap member 14. In other embodiments, different fasteners can be implemented that allow for the adjustment of the working length of each restraining strap.

For larger pets, additional restraining straps may be necessary. In some embodiments, the at least one intermediate restraining strap 10 can be provided as a plurality of intermediate restraining straps 24 that allow larger pets to be securely restrained to the support base 1, as can be seen in FIGS. 1 through 9. The plurality of intermediate restraining straps 24 is distributed along the support base 1 so that the plurality of intermediate restraining straps 24 provide enough support to the pet's body. In other embodiments, other restraining features can be implemented to accommodate larger pets.

As previously discussed, the support base 1 is an overall elongated flat structure that accommodates the desired pet. As can be seen in FIGS. 1 through 9, the support base 1 may further comprise a first base surface 6 and a second base surface 7 corresponding to the largest surfaces of the support base 1. In addition, the first base surface 6 is positioned opposite to the second base surface 7 across the support base 1 due to the overall flat shape of the support base 1. This design of the support base 1 allows the proximal restraining strap 8, the at least one intermediate restraining strap 10, and the distal restraining strap 9 to be secured to the support base 1 in different ways to allow for different configurations of the present invention.

In the preferred embodiment, the proximal restraining strap 8, the at least one intermediate restraining strap 10, and the distal restraining strap 9 can be permanently attached to the support base 1. As can be seen in FIGS. 1 through 9, the first strap end 11 of the proximal restraining strap 8, the first strap end 11 of the at least one intermediate restraining strap 10, and the first strap end 11 of the distal restraining strap 9 are each directly connected to the second base surface 7, adjacent to the first lengthwise edge 2.

Similarly, the second strap end 12 of the proximal restraining strap 8, the second strap end 12 of the at least one intermediate restraining strap 10, and the second strap end 12 of the distal restraining strap 9 are each directly connected to the second base surface 7, adjacent to the second lengthwise edge 3. This way, the proximal restraining strap 8, the at least one intermediate restraining strap 10, and the distal restraining strap 9 are permanently fixed to the support base 1. Further, the neck restraining collar 28 is tethered to the second base surface 7, adjacent to the first widthwise edge 4, to permanently secure the neck restraining collar 28 to the support base 1.

In another embodiment, the proximal restraining strap 8, the at least one intermediate restraining strap 10, and the distal restraining strap 9 can be removably attached to the support base 1 to allow the user to attach or remove the restraining straps necessary to restrain the target pet. To do so, the present invention may further comprise a plurality of base fasteners that facilitate the removable attachment of the restraining straps to the support base 1. For example, the plurality of base fasteners can be hook and loop fasteners, with the hook portion of each base fastener being positioned on the strap ends of each restraining strap. The loop portion of each base fastener can be provided on the second base surface 7 along the lengthwise edges of the support base 1. This way, the user can engage the hook portion of each base fastener to the corresponding loop portion to attach the desired restraining strap to the support base 1. The first strap end 11 of the proximal restraining strap 8, the first strap end 11 of the at least one intermediate restraining strap 10, and the first strap end 11 of the distal restraining strap 9 are each attached to the second base surface 7 by a corresponding base fastener of the plurality of base fasteners, adjacent to the first lengthwise edge 2. Similarly, the second strap end 12 of the proximal restraining strap 8, the second strap end 12 of the at least one intermediate restraining strap 10, and the second strap end 12 of the distal restraining strap 9 are each connected to the second base surface 7 by a corresponding base fastener of the plurality of base fasteners, adjacent to the second lengthwise edge 3. This way, the user can attach or remove any retraining strap to accommodate the target pet. In other embodiments, different base fasteners can be implemented that allow for the removable attachment of the target restraining strap to the support base 1.

In another embodiment, the proximal restraining strap 8, the at least one intermediate restraining strap 10, and the distal restraining strap 9 can be attached to the support base 1 without the use of the plurality of base fasteners. The present invention may further comprise a plurality of first hooks and a plurality of second hooks. The plurality of first hooks and the plurality of second hooks are designed to enable the secure attachment of the desired restraining strap to the support base 1. In addition, the proximal restraining strap 8, the at least one intermediate restraining strap 10, and the distal restraining strap 9 may each further comprise a first strap loop and a second strap loop. The first strap loop and the second strap loop enable the engagement of the strap ends of the desired restraining strap to the corresponding first hook of the plurality of first hooks and second hook of the plurality of second hooks, respectively.

This embodiment of the present invention can be arranged as follows: each first strap loop is terminally integrated into the corresponding first strap end 11 to secure each first strap loop to the corresponding restraining strap. Similarly, each second strap loop is terminally integrated into the corresponding second strap end 12 to secure each second strap loop to the corresponding restraining strap. Further, the plurality of first hooks is distributed along the first lengthwise edge 2, while the plurality of second hooks is distributed along the second lengthwise edge 3. This way, the plurality of first hooks and the plurality of second hooks are evenly distributed along the support base 1. Further, each of the plurality of first hooks is connected onto the first lengthwise edge 2 to secure the plurality of first hooks to the support base 1. Likewise, each of the plurality of second hooks is connected onto the second lengthwise edge 3 to secure the plurality of second hooks to the support base 1. Furthermore, to attach the desired restraining straps to the support base 1, each first strap loop is engaged with a corresponding first hook of the plurality of first hooks. This secures each first strap end 11 of the desired restraining straps to the corresponding first hook of the plurality of first hooks. Similarly, each second strap loop is engaged with a corresponding second hook of the plurality of second hooks to secure each second strap end 12 of the desired restraining straps to the corresponding second hooks of the plurality of second hooks. In other embodiments, different base features can be integrated into the support base 1 to allow for the removable attachment of the restraining straps to the support base 1.

Although the invention has been explained in relation to its preferred embodiment, it is to be understood that many other possible modifications and variations can be made without departing from the spirit and scope of the invention.

What is claimed is:

1. A pet restraint device comprising:
a support base;
a proximal restraining strap;
a distal restraining strap;
at least one intermediate restraining strap;
a rear restraining band;
a neck restraining collar;
the support base comprising a first lengthwise edge, a second lengthwise edge, a first widthwise edge, and a second widthwise edge;
the proximal restraining strap, the at least one intermediate restraining strap, and the distal restraining strap each comprising a first strap end and a second strap end;
the rear restraining band comprising a band body, a first band end, a second band end, a first band loop, and a second band loop;
the proximal restraining strap, the at least one intermediate restraining strap, and the distal restraining strap being distributed along the support base;
the proximal restraining strap being positioned adjacent to the first widthwise edge;
the distal restraining strap being positioned adjacent to the second widthwise edge;
the at least one intermediate restraining strap being positioned in between the proximal restraining strap and the distal restraining strap;
the first strap end of the proximal restraining strap, the first strap end of the at least one intermediate restraining strap, and the first strap end of the distal restraining strap being each mounted onto the support base, adjacent to the first lengthwise edge;
the second strap end of the proximal restraining strap, the second strap end of the at least one intermediate restraining strap, and the second strap end of the distal restraining strap being each mounted onto the support base, adjacent to the second lengthwise edge;
the first band end being positioned opposite to the second band end along the band body;
the first band loop being terminally integrated into the first band end;
the second band loop being terminally integrated into the second band end;
the first band loop being positioned adjacent to the first lengthwise edge;
the second band loop being positioned adjacent to the second lengthwise edge;
the distal restraining strap being slidably engaged through the first band loop and the second band loop of the rear restraining band;
the neck restraining collar being positioned adjacent to the proximal restraining strap; and
the neck restraining collar being tethered to the support base, adjacent to the first widthwise edge.

2. The pet restraint device as claimed in claim 1 further comprising:
the neck restraining collar comprising a collar body and a tethering strap;
the tethering strap being terminally connected to the support base; and
the tethering strap being terminally connected to the collar body, opposite to the support base.

3. The pet restraint device as claimed in claim 2 further comprising:
a first collar fastener piece;
a second collar fastener piece;
the collar body comprising a first collar end and a second collar end;
the first collar fastener piece being mounted onto the collar body, adjacent to the first collar end;
the second collar fastener piece being mounted onto the collar body, adjacent to the second collar end; and
the first collar fastener piece being engaged with the second collar fastener piece.

4. The pet restraint device as claimed in claim 2 further comprising:
a first strap fastener;
the tethering strap comprising a proximal strap section and a distal strap section;
the proximal strap section and the distal strap section each comprising a fixed section end and a free section end;
the fixed section end of the proximal strap section being centrally positioned along the first widthwise edge;
the fixed section end of the proximal strap section being terminally connected to the support base;
the fixed section end of the distal strap section being terminally connected to the collar body; and
the free section end of the proximal strap section being connected to the free section end of the distal strap section by the first strap fastener.

5. The pet restraint device as claimed in claim 4 further comprising:
the first strap fastener comprising a proximal fastener piece and a distal fastener piece;
the proximal fastener piece being mounted onto the proximal strap section, adjacent to the free section end of the proximal strap section;
the distal fastener piece being mounted onto the distal strap section, adjacent to the free section end of the distal strap section; and
the proximal fastener piece being engaged with the distal fastener piece.

6. The pet restraint device as claimed in claim 1 further comprising:
a chest restraining band;
the chest restraining band comprising a band body, a first band end, a second band end, a first band loop, and a second band loop;
the first band end being positioned opposite to the second band end along the band body;
the first band loop being terminally integrated into the first band end;
the second band loop being terminally integrated into the second band end;
the first band loop being positioned adjacent to the first lengthwise edge;
the second band loop being positioned adjacent to the second lengthwise edge; and
the proximal restraining strap being slidably engaged through the first band loop and the second band loop of the chest restraining band.

7. The pet restraint device as claimed in claim 1 further comprising:
the support base being a rectangular base;
the first lengthwise edge being positioned parallel and opposite to the second lengthwise edge across the support base;
the first widthwise edge being positioned parallel and opposite to the second widthwise edge across the support base;
the first lengthwise edge being positioned perpendicular to the first widthwise edge; and
the proximal restraining strap, the at least one intermediate restraining strap, and the distal restraining strap being positioned parallel to each other.

8. The pet restraint device as claimed in claim 1 further comprising:
the proximal restraining strap, the at least one intermediate restraining strap, and the distal restraining strap each further comprising a first strap member, a second strap member, and a strap eyelet;
the first strap member being positioned coincident to the first strap end;
the second strap member being positioned coincident to the second strap end;
the strap eyelet being terminally connected to the first strap member, offset from the first strap end; and
the second strap member being looped through the strap eyelet, offset from the second strap end.

9. The pet restraint device as claimed in claim 8 further comprising:
the proximal restraining strap, the at least one intermediate restraining strap, and the distal restraining strap each further comprising a second strap fastener;
the second strap fastener being mounted onto the second strap member, offset from the second strap end; and
the second strap fastener being attached onto the second strap member, adjacent to the second strap end.

10. The pet restraint device as claimed in claim 1 further comprising:
the at least one intermediate restraining strap being a plurality of intermediate restraining straps; and
the plurality of intermediate restraining straps being distributed along the support base.

11. The pet restraint device as claimed in claim 1 further comprising:
the support base further comprising a first base surface and a second base surface;
the first base surface being positioned opposite to the second base surface across the support base;
the first strap end of the proximal restraining strap, the first strap end of the at least one intermediate restraining strap, and the first strap end of the distal restraining strap being each connected to the second base surface, adjacent to the first lengthwise edge;
the second strap end of the proximal restraining strap, the second strap end of the at least one intermediate restraining strap, and the second strap end of the distal restraining strap being each connected to the second base surface, adjacent to the second lengthwise edge; and
the neck restraining collar being tethered to the second base surface, adjacent to the first widthwise edge.

12. A pet restraint device comprising:
a support base;
a proximal restraining strap;
a distal restraining strap;
at least one intermediate restraining strap;
a rear restraining band;
a neck restraining collar;
the support base comprising a first lengthwise edge, a second lengthwise edge, a first widthwise edge, and a second widthwise edge;
the proximal restraining strap, the at least one intermediate restraining strap, and the distal restraining strap each comprising a first strap end and a second strap end;
the rear restraining band comprising a band body, a first band end, a second band end, a first band loop, and a second band loop;
the neck restraining collar comprising a collar body and a tethering strap;
the proximal restraining strap, the at least one intermediate restraining strap, and the distal restraining strap being distributed along the support base;
the proximal restraining strap being positioned adjacent to the first widthwise edge;
the distal restraining strap being positioned adjacent to the second widthwise edge;
the at least one intermediate restraining strap being positioned in between the proximal restraining strap and the distal restraining strap;
the first strap end of the proximal restraining strap, the first strap end of the at least one intermediate restraining strap, and the first strap end of the distal restraining strap being each mounted onto the support base, adjacent to the first lengthwise edge;
the second strap end of the proximal restraining strap, the second strap end of the at least one intermediate restraining strap, and the second strap end of the distal restraining strap being each mounted onto the support base, adjacent to the second lengthwise edge;
the first band end being positioned opposite to the second band end along the band body;
the first band loop being terminally integrated into the first band end;
the second band loop being terminally integrated into the second band end;
the first band loop being positioned adjacent to the first lengthwise edge;
the second band loop being positioned adjacent to the second lengthwise edge;
the distal restraining strap being slidably engaged through the first band loop and the second band loop of the rear restraining band;
the neck restraining collar being positioned adjacent to the proximal restraining strap;
the neck restraining collar being tethered to the support base, adjacent to the first widthwise edge;
the tethering strap being terminally connected to the support base; and
the tethering strap being terminally connected to the collar body, opposite to the support base.

13. The pet restraint device as claimed in claim 12 further comprising:
a first collar fastener piece;
a second collar fastener piece;
the collar body comprising a first collar end and a second collar end;
the first collar fastener piece being mounted onto the collar body, adjacent to the first collar end;
the second collar fastener piece being mounted onto the collar body, adjacent to the second collar end; and
the first collar fastener piece being engaged with the second collar fastener piece.

14. The pet restraint device as claimed in claim 12 further comprising:
a first strap fastener;
the tethering strap comprising a proximal strap section and a distal strap section;
the proximal strap section and the distal strap section each comprising a fixed section end and a free section end;
the fixed section end of the proximal strap section being centrally positioned along the first widthwise edge;
the fixed section end of the proximal strap section being terminally connected to the support base;
the fixed section end of the distal strap section being terminally connected to the collar body; and
the free section end of the proximal strap section being connected to the free section end of the distal strap section by the first strap fastener.

15. The pet restraint device as claimed in claim 14 further comprising:
the first strap fastener comprising a proximal fastener piece and a distal fastener piece;
the proximal fastener piece being mounted onto the proximal strap section, adjacent to the free section end of the proximal strap section;
the distal fastener piece being mounted onto the distal strap section, adjacent to the free section end of the distal strap section; and
the proximal fastener piece being engaged with the distal fastener piece.

16. The pet restraint device as claimed in claim 12 further comprising:
a chest restraining band;
the chest restraining band comprising a band body, a first band end, a second band end, a first band loop, and a second band loop;
the first band end being positioned opposite to the second band end along the band body;
the first band loop being terminally integrated into the first band end;
the second band loop being terminally integrated into the second band end;
the first band loop being positioned adjacent to the first lengthwise edge;
the second band loop being positioned adjacent to the second lengthwise edge; and
the proximal restraining strap being slidably engaged through the first band loop and the second band loop of the chest restraining band.

17. The pet restraint device as claimed in claim 12 further comprising:
the support base being a rectangular base;
the first lengthwise edge being positioned parallel and opposite to the second lengthwise edge across the support base;
the first widthwise edge being positioned parallel and opposite to the second widthwise edge across the support base;
the first lengthwise edge being positioned perpendicular to the first widthwise edge; and
the proximal restraining strap, the at least one intermediate restraining strap, and the distal restraining strap being positioned parallel to each other.

18. The pet restraint device as claimed in claim 12 further comprising:
the proximal restraining strap, the at least one intermediate restraining strap, and the distal restraining strap each further comprising a first strap member, a second strap member, a strap eyelet, and a second strap fastener;
the first strap member being positioned coincident to the first strap end;
the second strap member being positioned coincident to the second strap end;
the strap eyelet being terminally connected to the first strap member, offset from the first strap end;
the second strap member being looped through the strap eyelet, offset from the second strap end;
the second strap fastener being mounted onto the second strap member, offset from the second strap end; and
the second strap fastener being attached onto the second strap member, adjacent to the second strap end.

19. The pet restraint device as claimed in claim 12 further comprising:
the at least one intermediate restraining strap being a plurality of intermediate restraining straps; and
the plurality of intermediate restraining straps being distributed along the support base.

20. The pet restraint device as claimed in claim 12 further comprising:
the support base further comprising a first base surface and a second base surface;
the first base surface being positioned opposite to the second base surface across the support base;
the first strap end of the proximal restraining strap, the first strap end of the at least one intermediate restraining strap, and the first strap end of the distal restraining strap being each connected to the second base surface, adjacent to the first lengthwise edge;
the second strap end of the proximal restraining strap, the second strap end of the at least one intermediate restraining strap, and the second strap end of the distal restraining strap being each connected to the second base surface, adjacent to the second lengthwise edge; and
the neck restraining collar being tethered to the second base surface, adjacent to the first widthwise edge.
